(19) United States
(12) Patent Application Publication
(10) Pub. No.: US 2014/0337457 A1
(43) Pub. Date: Nov. 13, 2014

(54) USING NETWORK ADDRESSABLE NON-VOLATILE MEMORY FOR HIGH-PERFORMANCE NODE-LOCAL INPUT/OUTPUT

(71) Applicant: DataDirect Networks, Inc., Chatsworth, CA (US)

(72) Inventors: Paul Nowoczynski, Brooklyn, NY (US); Michael Vildibill, San Diego, CA (US); Jason Cope, Columbia, MD (US); Pavan Uppu, Laurel, MD (US)

(73) Assignee: DataDirect Networks, Inc., Chatsworth, CA (US)

(21) Appl. No.: 14/274,395

(22) Filed: May 9, 2014

Related U.S. Application Data
(60) Provisional application No. 61/822,792, filed on May 13, 2013.

(51) Int. Cl. G06F 15/173

(52) U.S. Cl. CPC G06F 15/17331
USPC 709/212

(57) ABSTRACT

Data storage systems and methods for storing data in computing nodes of a super computer or compute cluster are described herein. The super computer storage may be integrated with or coupled with a primary storage system. In addition to a CPU and memory, non-volatile memory is included with the computing nodes as local storage. A high speed interconnect remote direct memory access (HRI) unit is also included with each computing node. When data bursts occur, data may be stored by a first computing node on the local storage of a second computing node through the HRI units of the computing nodes, bypassing the CPU of the second computing node. Further, the local storage of other computing nodes may be used to store redundant copies of data from a first computing node to make the super computer data resilient while not interfering with the CPU of the other computing nodes.

### RELATED APPLICATION INFORMATION

This patent claims priority from provisional patent application No. 61/822,792 filed May 13, 2013 which is incorporated by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to data stored in a data storage system and an improved architecture and method for storing data to and retrieving data from local storage in a high speed super computing environment.

2. Description of the Related Art

A file system is used to store and organize computer data stored as electronic files. File systems allow files to be found, read, deleted, and otherwise accessed. File systems store files on one or more storage devices. File systems store files on storage media such as hard disk drives and solid-state storage devices. The data may be stored as objects using a distributed data storage system in which data is stored in parallel in multiple locations.

The benefits of parallel file systems disappear when using localized storage. In a super computer, large amounts of data may be produced prior to writing the data to permanent or long term storage. Localized storage for high speed super computers such as exascale is more complex than that of tera and petascale predecessors. The primary issues with localized storage are the need to stage and de-stage intermediary data copies and how these activities impact application jitter in the computing nodes of the super computer. The bandwidth variation between burst capability and long term storage makes the issues challenging.

### DESCRIPTION OF THE DRAWINGS

FIG. 1 is a block diagram of a super computing system having local storage in each computing node, the super computing system coupled with a data storage system.

FIG. 2 is a flow chart of actions taken by a computing node of a super computer or computing cluster to store or put data.

FIG. 3 is a flow chart of actions taken by a computing node of a super computer or computing cluster to read or get data.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Environment

Super computers store a large quantity of data quickly. It is advantageous to store and make the data available as quickly as possible. To improve super computer throughput, blocking or waiting for data to be stored should be reduced as much as possible. Storing data in a tiered system in which data is initially stored in an intermediate storage consisting of non-volatile memory (NVM) and then later written to primary storage such as hard disk drives using the architecture described herein helps achieve increased supercomputer throughput. In this way, the NVM serves as a burst buffer and serves to reduce the amount of time computing nodes spend blocking or waiting on data to be written or read. As used herein NVM refers to solid state drives also known as silicon storage devices (SSDs), flash memory, NAND-based flash memory, phase change memory, spin torque memory, and other non-volatile storage that may be accessed quickly compared to primary storage such as hard disk drives. The speed to access NVM is typically an order of magnitude faster than accessing primary storage.

According to the methods described herein, when the computing nodes of a super computer or compute cluster create large amounts of data very quickly, the data is initially stored in NVM, which may be considered a burst buffer or local storage, before the data is stored in primary storage. The hardware configuration described herein combined with the methods described allow for increased computing throughput and efficiencies as the computing nodes do not need to wait or block when storing or retrieving data; provide for replication and resiliency of data before it is written to primary storage; and allow for access to data from local storage even when the local storage on a computing node is down or inaccessible.

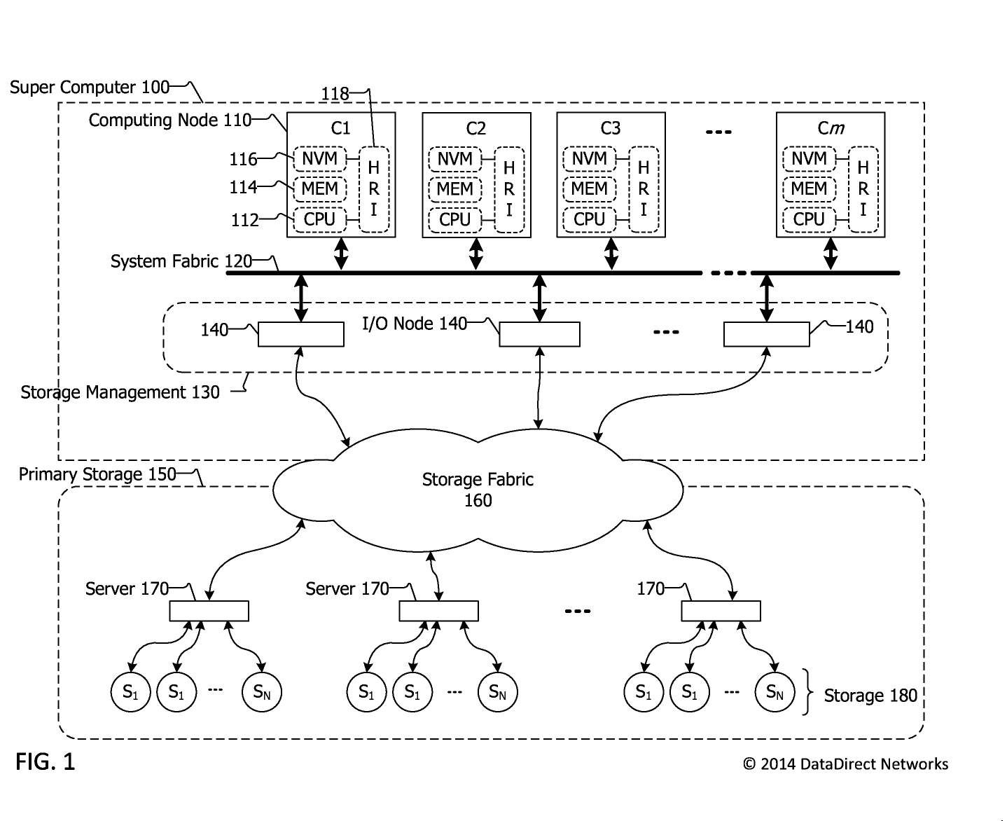

FIG. 1 is a block diagram of a super computing system 100 having local storage in each computing node 110, the super computing system coupled with a data storage system shown as primary storage 150. The super computer 100 may be a compute cluster that includes a plurality of computing nodes 110 shown as C1, C2, C3 through Cm. Similarly, the compute cluster may be a super computer. Each computing node has at least one core and may have multiple cores, such as 2, 4, 8, 32, etc. included in a central processing unit (CPU) 112. The computing nodes 110 of the super computer include local memory 114 such as random access memory that may be RAM, DRAM, and the like. Importantly, in the configuration described herein, the computing nodes each include local storage in the form of non-volatile memory (NVM) 116 unit and a high speed interconnect (HSI) remote direct memory access (RDMA) unit, collectively HRI 118. That is, as used herein HRI is shorthand for high speed interconnect remote direct memory access. The NVM 116 may be a chip, multiple chips, a chipset or an SSD. The HRI 118 may be a chip or chipset coupled or otherwise connected to the CPU 112 and the NVM 116. Not shown but included in the computing nodes 110 are a network interface chip or chipset that supports communications over the system fabric 120.

An advantage of the configuration shown and described herein is that the NVM 116 is included in the computing nodes 110 which results in an enhanced and increased speed of access to the NVM 116 by the CPU 112 in the same computing node 110. In addition, in this configuration, the use of local storage NVM 116, regardless of its location, is unbounded such that data from any of the CPUs 112 in any of the computing nodes C1 through Cm 110 may be stored to the local storage NVM of another computing node through the HRI 118 over system fabric 120. The configuration allows for one computing node to access another computing node's local storage NVM without interfering with the CPU processing on the other computing node. The configuration allows for data redundancy and resiliency as data from one computing node may be replicated in the NVM of other computing nodes. In this way, should the local storage NVM of a first computing node be busy, down or inaccessible, the first computing node can access the needed data from another computing node. Moreover, due to the use of HRI 118, the first computing node can access the needed data from another computing node with limited, minimal delay. This configuration provides for robust, non-blocking performing of the computing nodes. This configuration also allows for the handling of bursts such that when the local storage NVM on a first computing node is full, the computing node may access (that is, write to) the NVM at another computing node.

According to configuration shown in FIG. 1, an increase in performance results from the computing nodes being able to access their local storage NVM directly rather than through an I/O node; this results in increased data throughput to (and from) the NVM. When data is spread among the NVM on other computing nodes, there is some, limited overhead in processing and management when data from one computing node is written to the NVM of another computing node. This is because the I/O nodes 140 maintain information providing the address of all data stored in the NVM 116 (and the primary storage 150). When a CPU of one computing node writes data to the NVM of another computing node, an appropriate I/O node must be updated or notified about the computing node writing to the NVM of another computing node.

The computing nodes 110 may be in one or more racks, shelves or cabinets, or combinations thereof. The computing nodes are coupled with each other over system fabric 120. The computing nodes are coupled with input/output (I/O) nodes 140 via system fabric 120. The I/O nodes 140 a manage data storage and may be considered a storage management 130 component or layer. The system fabric 120 is a high speed interconnect that may conform to the INFINIBAND, CASCADE, GEMINI architecture or standard and their progeny, may be an optical fiber technology, may be proprietary, and the like.

The I/O nodes 140 may be servers which maintain location information for stored data items. The I/O nodes 140 are quickly accessibly by the computing nodes 110 over the system fabric 120. The I/O nodes keep this information in a database. The database may conform to or be implemented using SQL, SQLITE®, MONGODB®, Voldemort, or other key-value store. That is the I/O nodes store meta data or information about the stored data, in particular, the location in primary storage 150 or the location in local storage NVM in the computing nodes. As used herein, meta data is information associated with data that describes attributes of the data. The meta data stored by the I/O nodes 140 may additionally include policy information, parity group information (PGI), data item (or file) attributes, file replay state, and other information about the stored data items. The I/O nodes 140 may be indexed and access the stored meta data according to the hash of metadata for stored data items. The technique used may be based on or incorporate the methods described in U.S. patent application Ser. No. 14/028,292 filed Sep. 16, 2013 e ntitled Data Storage Architecture and System for High Performance Computing.

Each of the I/O nodes 140 is coupled with the system fabric 120 over which the I/O nodes 140 receive data storage (that is, write or put) and data access (that is, read or get) requests from computing nodes 110 as well as information about the location where data is stored in the local storage NVM of the computing nodes. The I/O nodes also store pertinent policies for the data. The I/O nodes 140 manage the distribution of data items from the super computer 100 so that data items are spread evenly across the primary storage 150. Each of the I/O nodes 140 is coupled with the storage fabric 160 over which the I/O nodes 140 send data storage and data access requests to the primary storage 150 via a network 160. The storage fabric 160 spans both the super computer 100 and primary storage 150 or be included between them.

The primary storage 150 typically includes multiple storage servers 170 that are independent of one another. The storage servers 170 may be in a peer-to-peer configuration. The storage servers may be geographically dispersed. The storage servers 170 and associated storage devices 180 may replicate data included in other storage servers. The storage servers 170 may be separated geographically, may be in the same location, may be in separate racks, may be in separate buildings on a shared site, may be on separate floors of the same building, and arranged in other configurations. The storage servers 170 communicate with each other and share data over storage fabric 160. The servers 170 may augment or enhance the capabilities and functionality of the data storage system by promulgating policies, tuning and maintaining the system, and performing other actions.

The storage fabric 160 may be a local area network, a wide area network, or a combination of these. The storage fabric 160 may be wired, wireless, or a combination of these. The storage fabric 160 may include wire lines, optical fiber cables, wireless communication connections, and others, and may be a combination of these and may be or include the Internet. The storage fabric 160 may be public or private, may be a segregated network, and may be a combination of these. The storage fabric 160 includes networking devices such as routers, hubs, switches and the like.

The term data as used herein includes multiple bits, multiple bytes, multiple words, a block, a stripe, a file, a file segment, or other grouping of information. In one embodiment the data is stored within and by the primary storage as objects. As used herein, the term data is inclusive of entire computer readable files or portions of a computer readable file. The computer readable file may include or represent text, numbers, data, images, photographs, graphics, audio, video, computer programs, computer source code, computer object code, executable computer code, and/or a combination of these and similar information.

The I/O nodes 140 and servers 170 are computing devices that include software that performs some of the actions described herein. The I/O nodes 140 and servers 170 may include one or more of logic arrays, memories, analog circuits, digital circuits, software, firmware, and processors such as microprocessors, field programmable gate arrays (FPGAs), application specific integrated circuits (ASICs), programmable logic device (PLDs) and programmable logic array (PLAs). The hardware and firmware components of the servers may include various specialized units, circuits, software and interfaces for providing the functionality and features described herein. The processes, functionality and features described herein may be embodied in whole or in part in software which operates on a controller and/or one or more I/O nodes 140 and may be in the form of one or more of firmware, an application program, object code, machine code, an executable file, an applet, a COM object, a dynamic linked library (DLL), a dynamically loaded library (.so), a script, one or more subroutines, or an operating system component or service, and other forms of software. The hardware and software and their functions may be distributed such that some actions are performed by a controller or server, and others by other controllers or servers.

A computing device as used herein refers to any device with a processor, memory and a storage device that may execute instructions such as software including, but not limited to, server computers. The computing devices may run an operating system, including, for example, versions of the Linux, Unix, MS-DOS, MICROSOFT® Windows, Solaris, Android, Chrome, and APPLE® Mac OS X operating systems. Computing devices may include a network interface in the form of a card, chip or chip set that allows for communication over a wired and/or wireless network. The network interface may allow for communications according to various protocols and standards, including, for example, versions of Ethernet, INFINIBAND network, Fibre Channel, and others. A computing device with a network interface is considered network capable.

Referring again to FIG. 1, each of the storage devices 180 include a storage medium or may be an independent network attached storage (NAS) device or system. The term “storage media” is used herein to refer to any configuration of hard disk drives (HDDs), solid-state drives (SSDs), silicon storage devices, magnetic tape, or other similar magnetic or silicon-based storage media. Hard disk drives, solid-states drives and/or other magnetic or silicon-based storage media 180 may be arranged according to any of a variety of techniques.

The storage devices 180 may be of the same capacity, may have the same physical size, and may conform to the same specification, such as, for example, a hard disk drive specification. Example sizes of storage media include, but are not limited to, 2.5″ and 3.5″. Example hard disk drive capacities include, but are not limited to, 1, 2 3 and 4 terabytes. Example hard disk drive specifications include Serial Attached Small Computer System Interface (SAS), Serial Advanced Technology Attachment (SATA), and others. An example server 170 may include 16 three terabyte 3.5″ hard disk drives conforming to the SATA standard. In other configurations, there may be more or fewer drives, such as, for example, 10, 12, 24 32, 40, 48, 64, etc. In other configurations, the storage media 180 in a storage node 170 may be hard disk drives, silicon storage devices, magnetic tape devices, optical media or a combination of these. In some embodiments, the physical size of the media in a storage node may differ, and/or the hard disk drive or other storage specification of the media in a storage node may not be uniform among all of the storage devices in primary storage 150.

The storage devices 180 may be included in a single cabinet, rack, shelf or blade. When the storage devices 180 in a storage node are included in a single cabinet, rack, shelf or blade, they may be coupled with a backplane. A controller may be included in the cabinet, rack, shelf or blade with the storage devices. The backplane may be coupled with or include the controller. The controller may communicate with and allow for communications with the storage devices according to a storage media specification, such as, for example, a hard disk drive specification. The controller may include a processor, volatile memory and non-volatile memory. The controller may be a single computer chip such as an FPGA, ASIC, PLD and PLA. The controller may include or be coupled with a network interface.

The rack, shelf or cabinet containing a storage zone may include a communications interface that allows for connection to other storage zones, a computing device and/or to a network. The rack, shelf or cabinet containing storage devices 180 may include a communications interface that allows for connection to other storage nodes, a computing device and/or to a network. The communications interface may allow for the transmission of and receipt of information according to one or more of a variety of wired and wireless standards, including, for example, but not limited to, universal serial bus (USB), IEEE 1394 (also known as FIREWIRE® and I.LINK®), Fibre Channel, Ethernet, WiFi (also known as IEEE 802.11). The backplane or controller in a rack or cabinet containing storage devices may include a network interface chip, chipset, card or device that allows for communication over a wired and/or wireless network, including Ethernet, namely storage fabric 160. The controller and/or the backplane may provide for and support 1, 2, 4, 8, 12, 16, etc. network connections and may have an equal number of network interfaces to achieve this.

As used herein, a storage device is a device that allows for reading from and/or writing to a storage medium. Storage devices include hard disk drives (HDDs), solid-state drives (SSDs), DVD drives, flash memory devices, and others. Storage media include magnetic media such as hard disks and tape, flash memory, and optical disks such as CDs, DVDs and BLU-RAY® discs and other optically accessible media.

In some embodiments, files and other data may be partitioned into smaller portions and stored as multiple objects in the primary storage 150 and among multiple storage devices 180 associated with a storage server 170. Files and other data may be partitioned into portions referred to as objects and stored among multiple storage devices. The data may be stored among storage devices according to the storage policy specified by a storage policy identifier. Various policies may be maintained and distributed or known to the servers 170 in the primary storage 150. The storage policies may be system defined or may be set by applications running on the computing nodes 110.

As used herein, storage policies define the replication and placement of data objects in the data storage system. Example replication and placement policies include, full distribution, single copy, single copy to a specific storage device, copy to storage devices under multiple servers, and others. A character (e.g., A, B, C, etc.) or number (0, 1, 2, etc.) or combination of one or more characters and numbers (A1, AAA, A2, BC3, etc.) or other scheme may be associated with and used to identify each of the replication and placement policies.

The local storage NVM 116 included in the computing devices 110 may be used to provide replication, redundancy and data resiliency within the super computer 100. In this way, according to certain policies that may be system pre-set or customizable, the data stored in the NVM 116 of one computing node 110 may be stored in whole or in part on one or more other computing nodes 110 of the super computer 100. Partial replication as defined below may be implemented in the NVM 116 of the computing nodes 110 of the super computer 100 in a synchronous or asynchronous manner. The primary storage system 150 may provide for one or multiple kinds of storage replication and data resiliency, such as partial replication and full replication.

As used herein, full replication replicates all data such that all copies of stored data are available from and accessible in all storage. When primary storage is implemented in this way, the primary storage is a fully replicated storage system. Replication may be performed synchronously, that is, completed before the write operation is acknowledged; asynchronously, that is, the replicas may be written before, after or during the write of the first copy; or a combination of each. This configuration provides for a high level of data resiliency. As used herein, partial replication means that data is replicated in one or more locations in addition to an initial location to provide a limited desired amount of redundancy such that access to data is possible when a location goes down or is impaired or unreachable, without the need for full replication. Both the local storage NVM 116 with HRI 118 and the primary storage 150 support partial replication.

In addition, no replication may be used, such that data is stored solely in one location. However, in the storage devices 180 in the primary storage 150, resiliency may be provided by using various techniques internally, such as by a RAID or other configuration.

### Processes

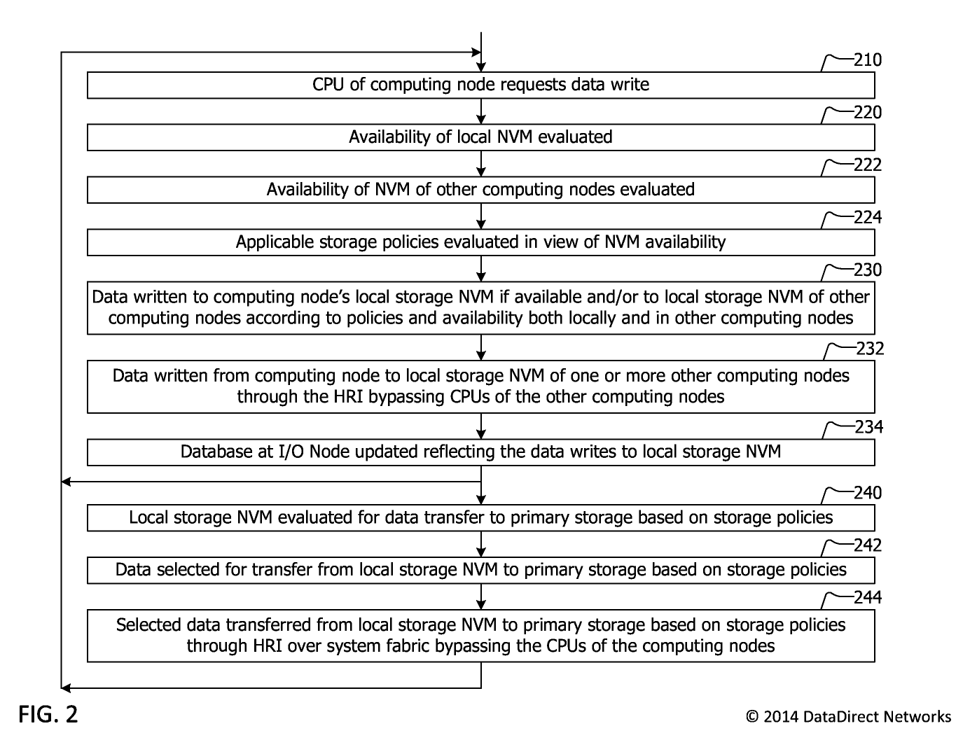

FIG. 2 is a flow chart of actions taken by a computing node of a super computer or computing cluster to store or put data in a data storage system. This method is initiated and executed by an application or other software running on each computing node. The CPU of a computing node requests data write, as shown in block 210. The availability of local NVM or local storage is evaluated, as shown in block 220. The check for NVM availability may include one or more of checking for whether the NVM is full, is blocked due to other access occurring, is down or has a hardware malfunction, or is inaccessible for another reason. The availability of NVM of other computing nodes is also evaluated, as shown in block 222. The availability of local storage NVM at at least one of the other computing nodes in the super computer is evaluated. The number of computing nodes evaluated may be based on a storage policy for the super computer or a storage policy for the data, and may be system defined or user customizable. This evaluation may be achieved by the application or other software running on the CPU of a computing node 110 checking with an I/O node 140 to obtain one or more identifiers of computing nodes with available NVM. In some configurations, the check with the I/O node may not be necessary as direct communication with the NVM at other computing nodes may be made. This may include the application or other software running on the CPU of a computing node 110 communicating with the local storage NVM 116 on other computing nodes 110 over the system fabric 120 and through the HRI 118 at each computing node 110. This communication may be short and simple, amounting to a ping or other rudimentary communication. This communication may include or be a query or request for the amount of available local storage NVM at the particular computing node.

Applicable storage policies are evaluated in view of local storage NVM availability, as shown in block 224. For example, the evaluation may include considering when partial replication to achieve robustness and redundancy is specified, one or more the number of NVM units at other computing nodes is selected as targets to store the data stored in local storage NVM. The evaluation may include considering when partial replication to achieve robustness and redundancy is specified, and the local storage NVM is not available, two or more local storage NVM units at other computing nodes are selected as targets to store the data. The evaluation may include considering when no replication is specified and the local storage NVM is not available, no NVM units at other computing nodes are selected to store the data stored in local storage NVM. Other storage policy evaluations in view of NVM available may be performed.

Data is written to the computing node's local storage NVM if available and/or to local storage NVM of one or more other computing nodes according to policies and availability of local storage NVM both locally and in the other computing nodes, as shown in block 230. The computing node may be considered a source computing node the other computing nodes may be considered target or destination computing nodes. Data is written from the computing node to the local storage NVM of one or more other computing nodes through the HRI bypassing the CPUs of the other computing nodes, as shown in block 232. More specifically, when data is to be stored in the local storage NVM of one or more other computing nodes, data is written from the local storage NVM of the source computing node to the local storage NVM of one or more target computing nodes through the HRI on the source and destination computing nodes, bypassing the CPUs of the destination computing nodes. Similarly, when data is to be stored in the local storage NVM of one or more other computing nodes and the local storage NVM of the computing node is unavailable or inaccessible, data is written from the local memory of the source computing node to the local storage NVM of one or more destination computing nodes through the HRI on the course and destination computing nodes, bypassing the CPUs of the target computing nodes. According to the methods and architecture described herein, when a write is made, a one to one communication between the HRI units on source and destination computing nodes occurs such that no intermediary or additional computing nodes are involved in the communication from source to destination over the system fabric.

After a write is made to local storage NVM as shown in blocks 230 and 232, the database at an I/O node is updated reflecting the data writes to local storage NVM, as shown in block 234. This may be achieved be a simple message from the computing node to the I/O node over the system fabric reporting data stored and location stored, which causes the I/O node to update its database. The flow of actions then continues back at block 210, described above, or continues with block 240.

Referring now to block 240, the application or other software executing on the CPU in a computing node evaluates local storage NVM for data transfer to primary storage based on storage policies. This evaluation includes a first computing node evaluating its local storage NVM and, if applicable, the local storage NVM of other computing nodes written to by the first computing node. The policies may be CPU/computing node policies and/or policies associated with the data items stored in the local storage NVM. The policies may be based on one or a combination of multiple policies including send oldest data (to make room for newest data); send least accessed data; send specially designated data; send to primary storage when CPU quiet, not executing; and others. Data is selected for transfer the NVM to the primary storage based on storage policies, as shown in block 242. This selection is made by software executing on a first computing node evaluating its local storage NVM and, if applicable, the local storage NVM of other computing nodes written by the first computing node. The selected data is transferred from local storage NVM to primary storage based on storage policies through the HRI over the system fabric, bypassing the CPUs of the computing nodes, as shown in block 244.

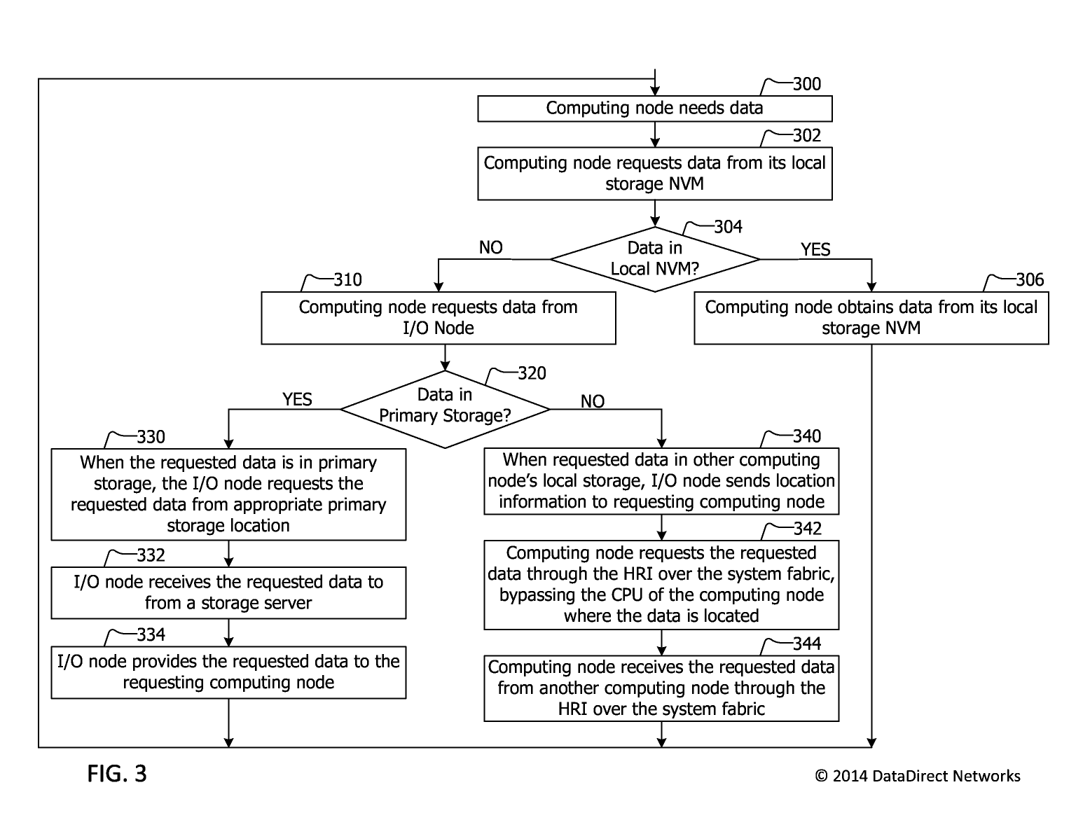

FIG. 3 is a flow chart of actions taken by a computing node of a super computer or computing cluster to read or get data. An application executing on a computing node needs data, as shown in block 300. The computing node requests data from its local storage NVM, as shown in block 302. A check is made to determine if the data is located in the local storage NVM on the computing node, as shown in block 304. When the data is located in the local storage NVM on the computing node, as shown in block 304, the computing node obtains the data from its local storage NVM as shown in block 306. The flow of actions then continues at block 300.

When the data is not located in the local storage NVM on the computing node, as shown in block 304, the computing node requests data from an appropriate I/O node, as shown in block 310. This is achieved by sending a data item request over the system fabric 120 to the I/O node 140.

The I/O node checks whether the data item is in primary storage by referring to its database, as shown in block 320. When the requested data is in primary storage, the requested data is obtained from the primary storage. That is, when the requested data is in primary storage, as shown in block 320, the I/O node requests the requested data from an appropriate primary storage location, as shown in block 330. This is achieved by the I/O node sending a request over the storage fabric 160 to an appropriate storage server 170. The I/O node receives the requested data from a storage server, as shown in block 332. The I/O node provides the requested data to the requesting computing node, as shown in block 334. The flow of actions then continues at block 300.

When the requested data is not in primary storage, as shown in block 320, (and not in local storage NVM, as shown in block 304,) the requested data is located in local storage of a computing node that is not the requesting computing node. When the requested data is in another computing node's local storage NVM, the I/O node looks up the location of the requested data in its database and sends the local storage NVM location information for the requested data to the requesting computing node, as shown in block 340. The computing node obtains the requested data through the HRI, bypassing the CPU of the computing node where the data is located. That is, the computing node requests the requested data through the HRI over the system fabric, bypassing the CPU of the computing node where the data is located, as shown in block 342. The computing node receives the requested data from another computing node through the HRI over the system fabric, as shown in block 344. According to the methods and architecture described herein, when a read is made, a one to one communication between the HRI units on the requesting computing node and the other computing node occurs such that no intermediary or additional computing nodes are involved in the communication over the system fabric.

As described in FIGS. 2 and 3, the actions taken in the configuration shown in FIG. 1 provide for handling of data bursts such that when the local storage on one computing node is full or unavailable, the computing node may access (that is, write to) the local storage of another computing node. This allows for robust, non-blocking performance of computing nodes when data intensive computations are performed by the computing nodes of a super computer. In addition, using the methods set forth herein with the architecture that includes both HRI units and local storage, the supercomputer provides for data resiliency by redundancy of the data among computing nodes without interfering with the processing of CPUs at the computing nodes.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., “primary”, “secondary”, “tertiary”, etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A data storage method comprising:
a CPU of a first computing node of a super computer issuing a data write request;
evaluating the availability of local storage in the first computing node;
evaluating the availability of local storage in at least one other computing node of a plurality of computing nodes;
evaluating storage policies in view of the evaluating the availability of local storage in the first computing node and evaluating the availability of local storage in the at least one other computing node;
writing data to local storage of at least one of the other computing nodes according to the storage policies and the availability of local storage both in the first computing node and in other computing nodes, including writing data from the first computing node to the local storage of the at least one other computing node through a high speed interconnect remote direct memory access (HRI), bypassing the CPU of the at least one other computing node.

2. The data storage method of claim 1 wherein the local storage is non-volatile memory.

3. The data storage method of claim 2 wherein the non-volatile memory is silicon-based.

4. The data storage method of claim 1 wherein the evaluating the availability of local storage in at least one other computing node comprises sending at least one of a ping to the other computing node and/or sending an available memory query to the other computing node.

5. The data storage method of claim 1 wherein the evaluating the availability of local storage in the first computing node comprises checking whether the local storage is accessible and/or full.

6. The data storage method of claim 1 wherein the writing is achieved over a system fabric over which the computing nodes are coupled for communication.

7. The data storage method of claim 6 wherein the system fabric is a high speed interconnect

8. The data storage method of claim 1 further comprising:
reporting location information of data written to local storage in the at least one other computing node to an input/output node coupled to the computing nodes via a system fabric.

9. A data retrieval method comprising:
a first computing node of a plurality of computing nodes checking whether needed data is in local storage;
when the data is not available from the local storage, the first computing node requesting the data from an input/output (I/O) node;
when the data is not in primary storage, the first computing node receiving from the I/O node a location in local storage of a second computing node of the plurality of computing nodes where the needed data is located;
the first computing node requesting the needed data through a high speed interconnect remote direct memory access (HRI) unit over a system fabric, bypassing a central processing unit (CPU) of the second computing node where the needed data is located;
the first computing node receiving the requested data from the second computing node through the HRI over the system fabric.

10. The data retrieval method of claim 9 wherein checking whether needed data is in local storage includes checking whether the local storage is accessible.

11. The data retrieval method of claim 9 wherein the local storage is non-volatile memory.

12. The data retrieval method of claim 9 wherein the non-volatile memory is silicon-based.

13. The data retrieval method of claim 9 further comprising:
when the data is in the primary storage, the I/O node
requesting the requested data from an appropriate primary storage location,
receiving the requested data to from a storage server,
providing the requested data to the requesting computing node;

14. A super computer comprising:
a plurality of computing nodes, each computing node including a central processing unit (CPU), a memory, a local storage, and a high speed interconnect remote direct memory access (HRI) unit;
a plurality of input/output nodes;
a system fabric through which the computing nodes communicate with each other and with the input/output nodes, wherein the system fabric is a high speed interconnect,
wherein each of the plurality of computing nodes are configured to access the local storage of other computing nodes via the HRI unit over the system fabric thus bypassing the CPUs of the other computing nodes.

15. The super computer of claim 14 wherein the local storage is non-volatile memory.

16. The super computer of claim 14 wherein the non-volatile memory is silicon-based.

17. The super computer of claim 14 wherein the memory is random access memory (RAM).

18. The super computer of claim 14 wherein the high speed interconnect conforms to one of INFINIBAND, CASCADE, GEMINI standards.

19. The super computer of claim 14 wherein the high speed interconnect is one of wired or fiber optic.

20. The super computer of claim 14 wherein the input/output node is a server computer.

21. The super computer of claim 14 wherein the input/output nodes each include a database to store location information for stored data.
